(19) United States
(12) Patent Application Publication
(10) Pub. No.: US 2006/0087702 A1
(43) Pub. Date: Apr. 27, 2006

(54) Image capturing apparatus

(75) Inventors: Tomonori Satoh, Sakai-shi (JP); Shinichi Maehama, Osaka-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/257,218

(22) Filed: Oct. 24, 2005

(30) Foreign Application Priority Data
Oct. 25, 2004 (JP) 2004-309974

(51) Int. Cl. H04N 1/40

(52) U.S. Cl. 358/461

(57) ABSTRACT

An image capturing apparatus having an image capturing portion that captures an image of an object, a memory that has an area for storing reference gain information representative of a reference gain value for each of R, G and B at a predetermined pixel point in each block when an assumed image area corresponding to the captured image is divided into a plurality of blocks, an interpolator that calculates the gain value for each color for each pixel in each block by an interpolation calculation based on the reference gain information stored in the memory, and a shading corrector that receives interpolation gain information representative of the gain value calculated by the interpolator and the reference gain information, and performs color shading correction on the captured image based on the received interpolation gain information and reference gain information.

### CROSS-REFERENCE TO RELATED APPLICATION

This application is based on Japanese Patent Application No. 2004-309974 filed in Japan on Oct. 25, 2004 the entire content of which is hereby incorporated by reference.

### BACKGROUND OF THE INVENTION

1. Field of the Invention

The present invention relates to an image capturing apparatus such as a digital camera, and more particularly, to an image capturing apparatus capable of shading correction.

2. Description of the Related Art

Conventionally, in image capturing apparatuses such as digital cameras, an image sensor comprising, for example, a CCD (charge coupled device) is provided and a taken image is obtained by capturing the subject light incident through the taking lens. In the taken image, there are cases where unevenness in density (brightness) occurs in the image due to unevenness in the sensitivity of the image sensor and the illumination of the light source or a reduction in the illumination of the periphery in a reduction optical system, that is, due to the light quantity of the periphery being small compared to that of to the center of the optical axis of the subject light because of the taking lens and its diaphragm (aperture value). Therefore, so-called shading correction (sensitivity correction) is performed to prevent the occurrence of unevenness by compensating for the small light quantity by performing a processing to change the gain (amplification factor) for each of the image capturing elements (each of the pixel positions) constituting the image sensor. For distinction from color shading correction described later, this shading correction will be referred to as “brightness shading correction.”

An example of a typical brightness shading correction circuit is shown in FIG. 7. In a brightness shading correction circuit 600 shown in the figure, image data and a brightness shading correction table are stored in storage areas 602 and 603 of a memory 601, respectively. The image data and the brightness shading correction table are transmitted to a multiplication circuit 607 of a brightness shading correction block 606 (by way of N1- and N2-channel FIFO buffers) by different DMA controllers 604 and 605, respectively. In the brightness shading correction table, data related to the gain (gain data) is written, and the multiplication circuit 607 multiplies each piece of pixel data in the image data by the gain data corresponding to the pixel data in succession (in synchronism). The image data converted through the brightness shading correction is successively transmitted to a storage area 609 (by way of an N3-channel FIFO buffer) for storage by a DMA controller 608. By multiplying each piece of pixel data of the taken image by a given gain by use of such a brightness shading correction circuit 600, the brightness shading correction to avoid the unevenness in density (brightness) is performed.

With respect to this shading, in recent years, a phenomenon, so-called color shading, such that the shading amount differs among R, G and B has noticeably occurred as the image sensor has become smaller with the required size reduction of digital cameras. Conventionally, to handle this problem of color shading, it is proposed to perform the color shading correction on each piece of pixel data based on the shading correction coefficients corresponding to the colors of the color filters.

By digital cameras (image sensors) being reduced in size, instead of conventionally adopted telecentric optical systems, optical systems having a finite exit pupil have come to be adopted as optical systems for cameras. Moreover, not only because of the size reduction of the image sensors but also because of requirements for higher image quality, for example, as shown in FIG. 8 showing a pixel portion section 700 and the manner in which light is incident thereon, a microlens (condenser lens) is provided for each pixel such as a pixel 701 in order that light is efficiently condensed (in FIG. 8, for the pixel 701, for example, large and small microlenses 703 and 704 are disposed in front of and behind an R color filter 702). The above-mentioned exit pupil tends to be reduced in size because it is easy to design, and for example, as shown in FIG. 9, as the microlenses, ones are used that are shrunk (pupil-corrected) according to the position of the exit pupil.

However, for example, as shown in the structure of the image sensor (image capturing elements) in FIGS. 10 and 11 (for example, in FIG. 10, one end side portion of the image sensor, and in FIG. 11, the other end side portion of the image sensor), the light quantity (exposure amount) obtained by each image capturing element differs among the colors because the image capturing elements of the image sensor are laterally asymmetrical substantially with respect to the optical axis and because of the dispersion at the microlenses by the above-mentioned exit pupil position or a problem in the structure of the image capturing elements (the light interception by the image sensor is insufficient because of the size reduction). For this reason, when the color shading correction is executed, it is necessary to multiply by a different longitudinally and laterally asymmetrical gain (gain curve) for each of R, G and B. Moreover, image capturing lenses are also strongly required to be reduced in size, and the influence, of errors at the time of assembly, that is, errors in manufacture such as the electrode structure of the image capturing elements and the position shift of the light interception portion, on the color shading is large. As described above, when consideration is made with the image capturing device and the lens as a pair, the occurring color shading is asymmetrical and extremely complicated.

Further, the absolute amount of the actually occurring color shading is extremely slight, and the color shading correction (gain curve) for each of R, G and B is required of extremely fine accuracy. Moreover, since the color shading correction requires a gain curve for each of R, G and B compared to the brightness shading correction, it is necessary that the capacity of the memory for storing the color shading correction table (gain table) be approximately three times in a simple calculation. Particularly, in small-size digital cameras, since the capacity of the internal memory is also limited, it is necessary that the capacity of the memory for storing the color shading correction table be as small as possible. The conventionally proposed art cannot handle the asymmetrical and complicated color shading and does not solve the problem of the memory capacity.

### SUMMARY OF THE INVENTION

A principal object of the present invention is to provide an image capturing apparatus capable of reducing the memory capacity.

Another object of the present invention is to provide an image capturing apparatus capable of reducing the capacity of the memory for storing data for correction such as the color shading correction table.

Another object of the present invention is to provide an image capturing apparatus capable of accurately performing the color shading correction on the asymmetrical and complicated color shading.

Another object of the present invention is to provide an image capturing apparatus capable of performing the brightness shading correction with a simple circuit structure using the circuit structure for performing the color shading correction without the provision of a circuit designed specifically for the brightness shading correction.

Another object of the present invention is to provide an image capturing apparatus capable of making an adjustment so that correction can be performed in an appropriate gain range in each of the color shading correction and the brightness shading correction.

The above-mentioned objects of the present invention are attained by providing the following image capturing apparatus configured to correct a color shading of each of R, G and B in a captured image based on predetermined gain information for each pixel of the image, said image capturing apparatus comprising:

an image capturing portion that captures an image of an object;

a memory that has an area for storing reference gain information representative of a reference gain value for each of R, G and B at a predetermined pixel point in each block when an assumed image area corresponding to the captured image is divided into a plurality of blocks;

an interpolator that calculates the gain value for each color for each pixel in each block by an interpolation calculation based on the reference gain information stored in the memory; and

a shading corrector that receives interpolation gain information representative of the gain value calculated by the interpolator and the reference gain information, and performs color shading correction on the captured image based on the received interpolation gain information and reference gain information.

The above-mentioned objects of the present invention are also attained by providing the following image capturing apparatus configured to correct a color shading of each of R, G and B in a captured image based on predetermined gain information for each pixel of the image, said image capturing apparatus comprising:

an image capturing portion that obtains an image of an object;

a memory that has an area for storing reference gain information for each of R, G and B;

a shading corrector that performs color shading correction on the captured image based on the reference gain information received from the memory; and

a gain switching member that transfers, of the reference gain information for each of R, G and B stored in the memory, gain information for either one color to the shading corrector,

wherein the shading corrector performs brightness shading correction on the captured image based on the reference gain information for the one color transferred from the gain switching member.

These and other objects, advantages and features of the invention will become apparent from the following description thereof taken in conjunction with the accompanying drawings, which illustrate specific embodiments of the invention.

### BRIEF DESCRIPTION OF DRAWINGS

These and other objects, advantages and features of the invention will become apparent from the following description thereof taken in conjunction with the accompanying drawings in which:

FIG. 1(a) is a front view of a digital camera to which an image capturing apparatus according to the present invention is applied;

FIG. 1(b) is an upper view of the digital camera to which the image capturing apparatus according to the present invention is applied;

FIG. 1(c) is a rear view of the digital camera to which the image capturing apparatus according to the present invention is applied;

FIG. 2 is a block diagram showing the electric structure of the digital camera shown in FIG. 1;

FIG. 3 is a block diagram showing an example of the circuit structure for performing the color shading correction and the brightness shading correction;

FIG. 4 is a conceptual diagram for explaining gain data in shading correction tables and an interpolation calculation based on the gain data;

FIG. 5 is a flowchart showing an example of an operation associated with the color shading correction;

FIG. 6 is a flowchart showing an example of an operation associated with the brightness shading correction;

FIG. 7 is a block diagram showing the circuit structure for performing the shading correction in the related art;

FIG. 8 is a view showing the pixel portion section and the manner in which light is incident thereon in the related art;

FIG. 9 is a schematic structural view of the image sensor for explaining the lens shrink technology in the related art;

FIG. 10 is a pixel portion cross-sectional view for explaining the laterally asymmetrical structure of the image capturing elements in the related art; and

FIG. 11 is a pixel portion cross-sectional view for explaining the laterally asymmetrical structure of the image capturing elements in the related art.

### DESCRIPTION OF THE PREFERRED EMBODIMENT

Hereinafter, an embodiment of the present invention will be described with reference to the drawings.

(Description of the External Structure of the Image Sensor)

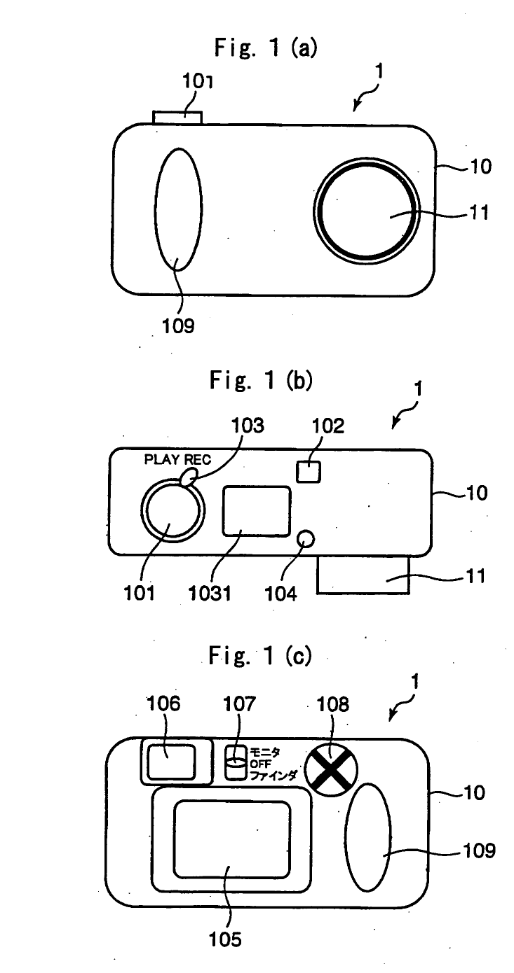

FIGS. 1(a) to 1(c) are views for explaining the external structure of a digital camera 1 to which an image capturing apparatus according to the present invention is suitably applied. FIG. 1(a) is a front view, FIG. 1(b) is an upper view, and FIG. 1(c) is a rear view. The digital camera 1 comprises a camera body 10 and a taking lens 11 disposed on one end side of the camera body 10. On the upper surface (top surface) of the camera body 10, a release switch 101, a power switch 102 (main switch), a mode changing switch 103 and a monitor enlarging switch 104 are disposed, and on the rear surface, an LCD monitor 105, an electronic view finder 106 (EVF) and various operation switches (buttons) such as a display changing switch 107 and a direction selecting switch 108 are disposed.

The taking lens 11 functions as a lens window that captures the subject light (light image), and constitutes an optical lens system (a zoom lens (focusing lens) block and a stationary lens block disposed in series along the optical axis of the subject light) for directing the subject light to a subsequently described image sensor 21 disposed inside the camera body 10.

The release switch 101 is for starting the photographing operation, and when this switch is depressed, the photographing operation (a series of photographing operations such that the subject light is captured by the image sensor 21, image processings such as the color shading correction are performed on the image data obtained thereby, and then, the image data is recorded in a subsequently described image memory 45 or the like) is executed. The power switch 102 is for switching on and off the digital camera 1. The mode changing switch 103 is for switching among photographing modes such as a photographing mode to perform automatic exposure control (AE control) and automatic focusing control (AF control), a still image photographing mode to take still images and a moving image photographing mode (continuous exposure mode) to take moving images, or various modes such as a live view mode to perform live view display of the taken image and a playback mode to perform playback display of images recorded in the image memory 45 or the like. The information on the switching by the mode changing switch 103 (mode setting information) or various pieces of setting information such as the number of exposures and the date information may be displayed on a display panel 1031 (liquid crystal panel) provided on the top of the camera body 10.

The monitor enlarging switch 104 is for enlarging a given area of the image displayed on the LCD monitor 105 or the electronic viewfinder 106 (causing the LCD monitor 105 or the electronic viewfinder 106 to operate as an electric magnifier). The LCD monitor 105 is constituted by a liquid crystal display (LCD) comprising a color liquid crystal display device, and displays the preview images for confirming the live view image taken in the live view mode and the images taken by depressing the release switch 101 (before they are stored in the image memory 45) or performs playback display of taken images recorded in the image memory 45 or the like in the playback mode. The electronic viewfinder 106 in which the part within the small window of the ocular portion is constituted by a liquid crystal screen functions as a viewfinder for displaying the image captured by the image sensor 21. The display changing switch 107 comprises, for example, a two-position slide switch, and is for switching the image display between the LCD monitor 105 and the electronic viewfinder 106.

The direction selecting switch 108 has, for example, a circular operation button, and four-way depression operations of this operation button in the upper, lower, right and left directions are detected. The direction selecting switch 108 is made multifunctional, and functions, for example, as an operation switch for selecting (changing) the frame to be played back or advancing the frame in an index screen where a plurality of thumbnail images playback-displayed on the LCD monitor 105 are arranged. Moreover, the direction selecting switch 108 may function as a zoom switch for changing the focal length of the zoom lens in the taking lens 11 or function as a switch for switching so that so-called real-time monitoring to display the finish of the image taken during exposure in real time is performed at the time of long-second exposure.

Inside the camera body 10, various body devices are disposed such as the image sensor 21 (CCD) that captures the subject light from the taking lens 11, a speaker that outputs various sound effects, a battery cavity that houses the battery, and a subsequently described memory card 413 as a recording medium. Here, the memory card 413 is disposed so as to be detachably attachable to the digital camera 1 in a memory card slot or the like. The camera body 10 may have, for example on a side surface, connector portions such as an AV output terminal and an USB terminal constituting I/F (interfaces) with external apparatuses and a jack for AC power or may be provided with a grip 109 for enabling the user to surely hold the camera with one hand (or both hands).

(General Description of the Electric Structure of the Image Capturing Apparatus)

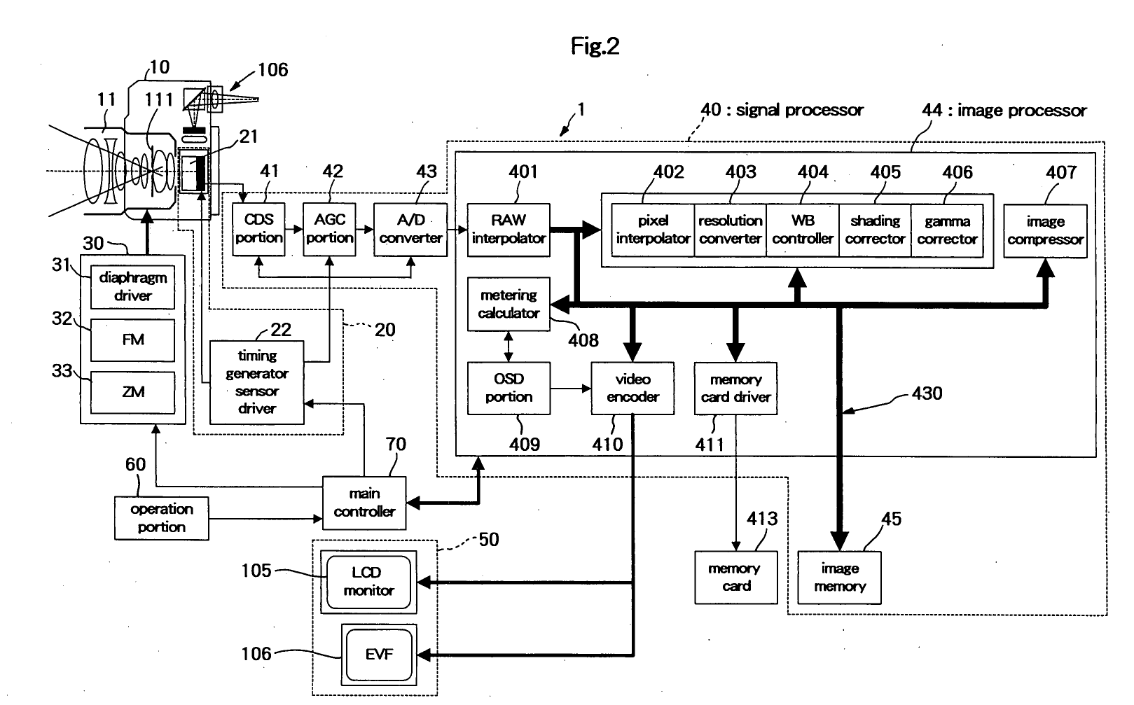

FIG. 2 is a block diagram showing the electric structure of the digital camera 1 shown in FIG. 1. The digital camera 1 comprises the taking lens 11, an image capturer 20, a lens controller 30, a signal processor 40, a display 50, an operation portion 60 and a main controller 70. The taking lens 11 is provided with a focusing lens, a zoom lens and a diaphragm 111 for adjusting the quantity of transmitted light, and is structured so as to be capable of performing focus adjustment and zoom adjustment by automatically moving the position of each lens. The image capturer 20 photoelectrically converts the subject light image incident through the taking lens 11, and outputs it as image signals. The image capturer 20 is provided with the image sensor 21 and a timing generator sensor driver 22.

The image sensor 21 captures the subject light (detects the subject brightness), that is, photoelectrically converts the subject light into image signals of the color components of R, G and B according to the light quantity of the subject light image formed by the taking lens 11, and outputs the image signals to the signal processor 40 through a predetermined buffer. Specifically, the image sensor 21 comprises color image capturing elements constituting 1CCD color area sensor of a so-called Bayer arrangement in which to the surface of each CCD of an area sensor where CCDs (charge coupled devices) are two-dimensionally arranged, primary color transmitting filters (color filters) of R (red), G (green) and B (blue) are pasted chequerwise pixel by pixel. While there are several choices such as a CCD image sensor, a CMOS image sensor and a VMIS image sensor for the image sensor 21, in the present embodiment, a CCD image sensor is adopted.

The timing generator sensor driver 22 generates driving control signals (an accumulation start signal and an accumulation end signal) for the image sensor 21 based on a photographing control signal inputted from the main controller 70, generates readout control signals of a so-called interlace method (a horizontal synchronization signal, a vertical synchronization signal, a transfer signal, etc.) based on a reference clock signal, and outputs the signals to the image sensor 21.

Moreover, the timing generator sensor driver 22 performs feedback control so that the exposure time of the image sensor 21 (the time of accumulation of the subject light by the image capturing elements; accumulation time) is appropriate. Specifically, for example, in the above-mentioned live view mode at the time of photographing, the aperture value for the diaphragm 111 is fixed at an open aperture value by a diaphragm driver 31, and under this condition, metering of, for example, a multi-pattern metering method is performed on the subject by the image sensor 21. Then, based on the light quantity data (evaluation value) by the metering, exposure control parameters (an exposure amount control parameter and a dynamic range control parameter) are calculated in the main controller 70, and based on the exposure control parameters and a preset program diagram (for example, the photoelectric conversion characteristic diagram of the image sensor 21), parameters for the feedback control are calculated. Then, based on the feedback control parameters, feedback control on the image sensor 21 is performed by the timing generator sensor driver 22. Here, the diaphragm 111 is used also as the shutter, and when photographing for recording is performed, the exposure amount for the image sensor 21 is controlled by the control of the aperture area of the diaphragm 111 by the diaphragm driver 31 based on the feedback control parameters.

The timing generator sensor driver 22 generates a timing signal (synchronous clock signal) for processing the image signals transmitted from the image sensor 21, by the signal processor 40, and inputs the timing signal to a CDS portion 41, an AGC portion 42 and an A/D converter 43 and the like in the signal processor 40.

The lens controller 30 controls the operation of each portion of the taking lens 11, and is provided with the diaphragm driver 31, a focusing lens driving motor (hereinafter, referred to as “FM”) 32 and a zoom lens driving motor (hereinafter, referred to as “ZM”) 33. The diaphragm driver 31 that controls the aperture value of the diaphragm incorporated in the taking lens 11 drives the diaphragm based on the information on the aperture value inputted from the main controller 70, and adjusts the aperture amount of the diaphragm.

The FM 32 performs the driving based on an AF control signal (for example, a control value such as the driving pulse number) inputted from the main controller 70, and moves the focusing lens incorporated in the taking lens 11 to the focus position. The ZM 33 performs the driving based on a zoom control signal (the operation information of the direction selecting switch 108) inputted from the main controller 70, and moves the zoom lens incorporated in the taking lens 11. When the operation information of, for example, the right switch of the direction selecting switch 108 is inputted from the main controller 70, the ZM 33 drives the zoom lens in the positive direction so as to move toward the telephoto side, and when the operation information of, for example, the left switch is inputted, the ZM 33 drives the zoom lens in the opposite direction so as to move toward the wide-angle side.

The signal processor 40 performs predetermined analog signal processings and digital signal processings on the image signals transmitted from the image sensor 21. The signal processings on the image signals are performed for each of the pixel signals constituting the image signals. The signal processor 40 comprises the CDS portion 41, the AGC portion 42, the A/D converter 43, an image processor 44 and the image memory 45.

The CDS portion 41 is provided with a CDS (correlated double sampling) circuit, and reduces the sampling noise of the image signal of an analog value outputted from the image sensor 21 (analog signal processing). The AGC 42 is provided with an AGC (automatic gain control) circuit, and adjusts the level of the image signal of an analog value inputted from the CDS portion 41 (analog signal processing). The AGC portion 42 also has a function to compensate for the level insufficiency of the taken image (performs sensitivity correction) when appropriate exposure is not obtained with the aperture value of the diaphragm 111 and the exposure time of the image sensor 21 (for example, when a subject with extremely low brightness is photographed). The gain (amplification factor) for the AGC portion 42 is set by the main controller 70.

The A/D converter 43 converts the image signal of an analog value (analog signal) normalized by the level adjustment by the AGC portion 42 into an image signal of a digital value (digital signal), and converts the pixel signal obtained by receiving light at each pixel of the image sensor 21 into pixel data of, for example, 12 bits. The image processor 44 performs predetermined image processings (digital image processings) on the image signals obtained by the A/D conversion by the A/D converter 43. The image processor 44 comprises a raw interpolator 401, a pixel interpolator 402, a resolution converter 403, a WB controller 404, a shading corrector 405, a gamma corrector 406, an image compressor 407, a metering calculator 408, an OSD portion 409, a video encoder 410 and a memory card driver 411.

The raw interpolator 401 generates full-color image data by performing color interpolation for the insufficient colors among the RGB of the pixels, on so-called raw data which is digital signals that are converted (through the A/D converter 43) from the subject light captured by the image sensor 21 and have undergone no processing. The raw interpolator 401 performs a processing to mask the pixel data of each of R, G and B in the generated full-color image, with a filter pattern for each of them. The pixel interpolator 402 performs a processing to interpolate (replace) each pixel value by use of a predetermined filter, for example, in order to remove noises of pieces of pixel data having extremely different values. Specifically, average interpolation is performed in which with respect to G having pixel values up to a high band, for example, the pixel value is replaced with the average value of the two median values of the four peripheral pixels of the target pixel by a median filter, and with respect to R and B, for example, the pixel value is replaced with the average value of the eight peripheral pixels.

The resolution converter 403 converts the resolution so that the number of recorded image pixels is the set number by performing a processing to reduce or thin out the horizontal and vertical pixel data in the image data having undergone the pixel interpolation by the pixel interpolator 402 and the like. The resolution converter 403 also creates low-resolution images such as images of 640×240 pixels for monitor display on the LCD monitor 105 or the electronic viewfinder 106 by thinning out, for example, the horizontal pixel data of the image data.

The WB controller 404 performs white balance (WB) control, on the image data having undergone the resolution conversion by the resolution converter 403 and the like, by independently performing the level adjustment on each of R, G and B by use of a predetermined level conversion table or the like so that the color balance of each of R, G and B is a predetermined color balance. Specifically, the part, assumed to be an originally white part, of the photographed subject is calculated based on the brightness and chroma data and the like, the average value of R, G and B, the G/R ratio, the G/B ratio and the like in that part are obtained, and the white balance control is performed by using these as the correction gains for R, G and B.

The shading corrector 405 performs shading correction such as the brightness shading correction or the color shading correction, on the image data having undergone the white balance adjustment by the WB controller 404 and the like, in order to perform a processing to correct the brightness in the image, the unevenness in R, G and B and the like. Details of the shading corrector 405 will be described later.

The gamma corrector 406 performs tone correction by correcting the gamma (γ) characteristic of each piece of pixel data. The gamma corrector 406 has a plurality of kinds of gamma correction tables of different gamma characteristics as look-up tables (LUTs), and performs gamma correction (nonlinear conversion) of the pixel data by a predetermined gamma correction table according to the set photographing scene (each output device). The image data having undergone the gamma correction is stored in the image memory 45 or the like.

The image compressor 407 performs image data compression. The metering calculator 408 performs a calculation as to the metering (for example, multi-pattern metering) for the subject, for example, at the time of focus adjustment in AF (automatic focusing). The OSD portion 409 is for displaying predetermined characters (text and graphics) so as to be superimposed on the screen of the LCD monitor 105 or the electronic viewfinder 106.

The video encoder 410 encodes the image data stored in the image memory 45 and/or the character image data by the OSD portion 409 by a video signal method such as NTSC (National TV Standards Committee) or PAL (phase alternating line). For example, when a preview image is displayed, the video encoder 410 encodes a low-resolution image of, for example, 640×240 pixels read out from the image memory 45, and played back this image on the LCD monitor 105 or on the electronic viewfinder 106 as a field image. The memory card driver 411 is an interface for performing writing (recording) and readout of image data (compressed image data) such as still images and moving images into and from the memory card 413 as a recording medium. At the time of image recording, a screennail image (VGA) for playback display is created concurrently with the recording of the image of the specified resolution, and the image is recorded so as to be linked to the screennail image. When this recorded image is played back, high-speed image display is enabled by displaying the screennail image.

The image memory 45 is for temporarily storing the image data at the time of calculation in each processing block of the image processor 44 and for storing the image data (image file) having undergone the signal processings by the image processor 44, and has a capacity capable of storing, for example, image data (image file) corresponding to a plurality of frames. The image data in the image memory 45 is accessed as required, and used in each portion. In the image memory 45, not only image data but also data used, for example, for the calculation in each processing block (for example, a shading correction table for a shading correction calculation by the shading corrector 405 described later) is stored.

The display 50 comprises the LCD monitor 105 and the electronic viewfinder 106, and displays the image transmitted from the video encoder 410. The display 50 may be provided with a non-illustrated VRAM or the like which is a buffer memory for storing images. The operation portion 60 comprises various operation switches such as the release switch 101 and the mode changing switch 103, and provides various operation instructions to the digital camera 1. The operation information by the operation portion 60 is outputted to the main controller 70.

The main controller 70 comprises a ROM (read only memory) storing control programs and the like, a RAM (random access memory) temporarily storing data for calculation and control processings and a CPU (central processing unit) reading the control programs or the like from the ROM and executing them, and performs the overall control of the digital camera 1. For example, when detecting an operation signal representing that the release switch 101 is half depressed, the main controller 70 causes each corresponding portion of the apparatus to execute preparation operations for taking a still image of the subject (preparation operations such as the setting of the exposure control value and the focus adjustment), and when detecting an operation signal representing that the release switch 101 is fully depressed, the main controller 70 causes each corresponding portion to execute the photographing operation, that is, a series of operations such that the image sensor 21 is exposed, image processings such as the color shading correction and brightness shading correction described later are performed on the image signals obtained by the exposure and the image signals are recorded in the image memory 45 or the memory card 413.

(Detailed Description of the Shading Corrector)

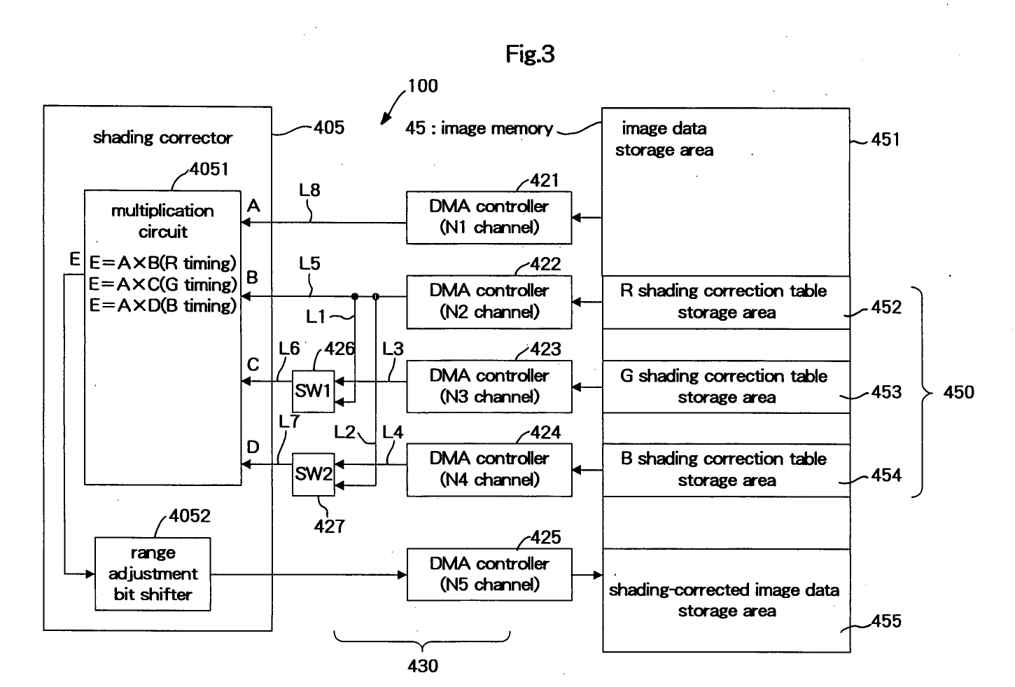

The shading correction by the shading corrector 405 will be described in detail. FIG. 3 is a block diagram showing an example of the circuit structure for performing the color shading correction and the brightness shading correction. As shown in FIG. 3, a shading correcting circuit 100 is provided with the shading corrector 405, the image memory 45 and a data transfer circuit 430 for transferring (exchanging) data between these processing blocks.

The image memory 45 is divided, with respect to the shading correction, into an image data storage area 451, an R shading correction table storage area 452, a G shading correction table storage area 453, a B shading correction table storage area 454 and a shading-corrected image data storage area 455. The R, G and B shading correction table storage areas 452 to 454 will be collectively called shading correction information storage area 450. In the image data storage area 451, image data for performing shading correction which image data has undergone the image processing (white balance adjustment) by the WB controller 404 and the like is stored.

In the R, G and B shading correction table storage areas 452 to 454, color shading correction tables for color shading correction for R, G and B are stored, respectively. The color shading correction tables are preset for R, G and B, and are tables (gain tables) in which gain data (gain values) by which each piece of pixel data of the image data stored in the image data storage area 451 is multiplied is written. The color shading correction tables stored in the storage areas will be described later in detail. In the shading-corrected image data storage area 455, the image data having undergone the shading correction (the multiplication of the image data and the gain data) by the shading corrector 405 is stored.

The data transfer circuit 430 is provided with DMA controllers 421 to 425 and changeover switches SW1 and SW2. The DMA controllers 421 to 425 are provided with a DMA (direct memory access) controller (LSI chip), and structured so that the data exchange (data transfer) between the image memory 45 and the shading corrector 405 is controlled by exclusively provided communication paths, DMA channels (N1 to N5 channels), without the data passing through the main controller 70 (CPU). Moreover, the DMA controllers 421 to 425 are provided with a FIFO (first-in first-out) buffer where the data stored first is taken out first, and the data is successively transferred.

The DMA controller 421 is provided in correspondence with the image data storage area 451, and the pixel data of the image data stored in the data storage area is successively transferred to the shading corrector 405. The DMA controllers 422 to 424 are provided in correspondence with the R, G and B shading correction table storage areas 452 to 454, respectively. The DMA controllers 422 to 424 have an interpolation calculation function for performing an interpolation calculation described later based on the gain data stored in the R, G and B shading correction table. By this, the gain data for all the pieces of pixel data of the image data is obtained, and the gain data (the gain data corresponding to the pixel data) is transferred to the shading corrector 405 in synchronism with the transfer of the pixel data of the image data through the FIFO buffer. The DMA controller 425 is provided in correspondence with the shading-corrected image data storage area 455, and the image data having undergone the shading correction (the color shading correction and the brightness shading correction described later) by the shading corrector 405 is successively transferred to the image memory 45 (in synchronism with the DMA controllers 421 to 424).

The shading corrector 405 is provided with a multiplication circuit 4051 and a range adjustment bit shifter 4052. The multiplication circuit 4051 multiplies each piece of pixel data of the image data by the gain data (multiplies each piece of pixel data by the gain). The multiplication circuit 4051 multiplies the pixel data of each of R, G and B in the image data transferred by the DMA controller 421, by the gain data for color shading correction for each color transferred from the DMA controllers 422 to 424, for example, in accordance with the synchronization timing at which the data is transferred. As described above, by multiplying the image data (image data of the color components of R, G and B) by the gain data for R, G and B), the color shading correction is performed.

In the circuit arrangement where the color shading correction is performed, as shown in the figure, the changeover switches SW1 and SW2 are provided between the DMA controller 423 and the multiplication circuit 4051 and between the DMA controller 424 and the multiplication circuit 4051, respectively, and the range adjustment bit shifter 4052 is provided in the shading corrector 405. To the changeover switches SW1 and SW2, signal lines for inputting R shading correction information from the DMA controller 422 are connected, for example, like signal lines L1 and L2. The changeover switch SW1 switches between the R shading correction information on the signal line L1 for transmission to the multiplication circuit 4051 and G shading correction information on a signal line L3. Likewise, the changeover switch SW2 switches between the R shading correction information on the signal line L2 and B shading correction information on a signal line L4.

With this circuit arrangement, the gain data (shading correction information) inputted to the multiplication circuit 4051 is unified into R gain data (the pieces of gain data transferred on signal lines L5 to L7 are all made R gain data) by the switching by the changeover switches SW1 and SW2, the multiplication circuit 4051 multiplies the image data transmitted on a signal line L8 by the gain data unified into R gain data (R pixel data is multiplied by R gain data, G pixel data is multiplied by R gain data, and B pixel data is multiplied by R gain data), and further, by performing a range adjustment on the image data having undergone the multiplication by the range adjustment bit shifter 4052, the brightness shading correction is performed. The gain range adjustment on the image data having undergone the gain data multiplication may be performed by use of the range adjustment bit shifter 4052 also when the color shading correction is performed. In this case, the range adjustment bit shifter 4052 is structured so that the adjustment in a larger gain range can be performed in the case of the brightness shading correction than in the case of the color shading correction.

Generally, the gain range subtly differs between the color shading correction and the brightness shading correction. The color shading correction requires slighter (finer) correction, whereas the brightness shading correction requires a large correction in a larger gain range. Since the color shading correction can serve also as the brightness shading correction also in theory, by forming a circuit for the color shading correction and making it possible to multiply the image data of each of R, G and B by the same gain by use of a shading correction table (gain table) of only one of R, G and B and perform the gain range adjustment by use of this circuit, both of the color shading correction and the brightness shading correction can be performed, so that a shading correction using the color and brightness shading corrections which shading correction is more suitable on the whole can be performed.

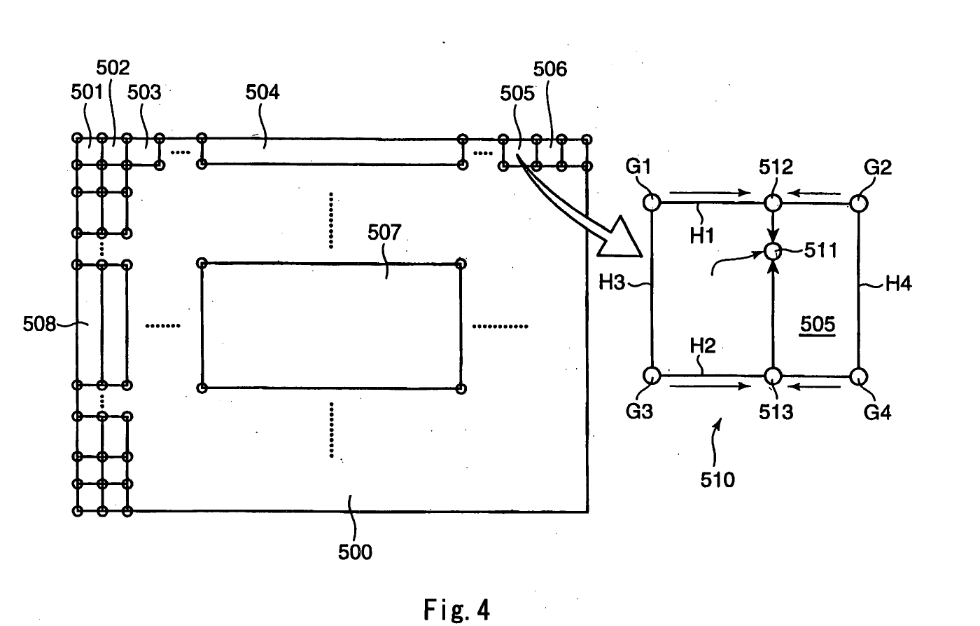

The shading correction tables stored in the R, G and B shading correction table storage areas 452 to 454 will be described in detail. FIG. 4 is a conceptual diagram for explaining the gain data in the shading correction tables and the interpolation calculation based on the gain data. In the figure, an image area 500 (assumed image area) is an image area corresponding to the image taken by the image sensor 21. This image area 500 is not an actually displayed image area but an image area assumed in explaining the gain data for each pixel of the taken image. Predetermined points on the image area 500 indicate the pixel points (pixels) at the corresponding locations on the taken image.

The image area 500 is divided (sectioned) into a plurality of blocks having different sizes such as blocks 501 to 504. In each of these blocks, the gain data serving as the reference for obtaining the gain value for each pixel in each corresponding block (hereinafter, referred to as reference gain data) is set. Specifically, the reference gain data is the gain values at pixel points (boundary pixel points) on the boundary (boundary line) between the blocks, and in this description, the gain values at the pixel points at the corners of each block (in other words, the pixels at the points of intersection of the vertical and horizontal dividing lines of the block division as shown in FIG. 4). In the R, G and B shading correction table storage areas 452 to 454, the shading correction tables (gain tables) in which the reference gain data at the corner pixel points of each block is written for each color are stored.

In the shading correction, based on the reference gain data, the gain value for each color for each pixel in each block is calculated by the interpolation calculation by the interpolation calculation function of the DMA controllers 422 to 424. The interpolation calculation will be described concretely. For example, as shown in the enlarged view of a block 505 at reference numeral 510, the pieces of reference gain data for the pixel points at the corners of the block 505 are designated G1 to G4, respectively. When the gain value for a pixel in the block 505, for example, a pixel 511 is obtained, for example, first, the gain value for a pixel 512 on the side H1 between the pieces of reference gain data G1 and G2 in the block 505 is calculated by performing interpolation using the pieces of reference gain data G1 and G2, the gain value for a pixel 513 on the side H2 between the pieces of reference gain data G3 and G4 is similarly calculated by performing interpolation using the pieces of reference gain data G3 and G4, and then, the gain value for the pixel 511 is obtained by performing interpolation using the gain values for the pixels 512 and 513. In this manner, the gain data for each of R, G and B at each coordinate in each block is calculated. However, the method of interpolation of the gain value at each pixel point in each block is not limited thereto; a method may be adopted such that after the gain values for pixels on the sides H3 and H4 are calculated, the gain value of the pixel 511 is obtained by interpolating them.

The sides H1 to H4 of the block may be regarded as the boundaries (boundary lines) between blocks. While the side H1 of the block 505 is not a boundary between blocks (is a side of the image area 500), such a side (H1) that is not a boundary between blocks in actuality is also included in the “boundary.”

Moreover, the pixel points at the corners of each block and a pixel point on each side, that is, the reference gain data of each block and the gain data for a pixel point on each side (obtained by interpolation) may be handled, for example, as data for either one of adjoining blocks or may be shared as data for both of these blocks. For example, in the block 505, the reference gain data G2 on the right side H4 and at the corner may be handled as data for the block 506 adjoining the block 505 on the right side (the reference gain data on the left side of the block 505 and at the upper left corner pixel point) or may be handled as data shared with the block 506 (data for the block 505 and also data for the block 506).

The image area 500 is divided into blocks so that blocks closer to the periphery of the image area 500 have smaller sizes (the block size decreases from the center toward the periphery of the image area 500). For example, the sizes of the blocks 501 to 504 and the block 508 on the periphery of the image area 500 are smaller than the size of the block 507 in a central part of the image area 500. Since the gain (gain change) generally increases (the steepness of the gain curve increases) toward the periphery of the image area 500, that is, since the color shading amount in the vicinity of the center of the image area 500 and the color shading amount on the periphery are largely different from each other, in order to accurately correct the color shading having such a characteristic, the image area 500 is divided so that the size of the blocks decreases toward the periphery. Since the gain curve generally has little inclination in the center of the image area 500 in the color shading (the difference in color shading is small in the vicinity of the center), the image area 500 may be divided into blocks so that the block size in the vicinity of the center is extremely large compared to the sizes of the blocks on the periphery.

Moreover, it is preferable that different block division patterns be set among R, G and B. That is, it is preferable that an individual image area (corresponding to the image area 500) be provided for each of R, G and B and the sizes of the blocks within these image areas be set to suitable ones corresponding to R, G and B. By this, color shading correction based on the block division pattern corresponding to each color can be independently performed for each color without the block division pattern unified into one of R, G and B, so that the color shading correction can be performed with higher accuracy.

(Description of Operation Flows)

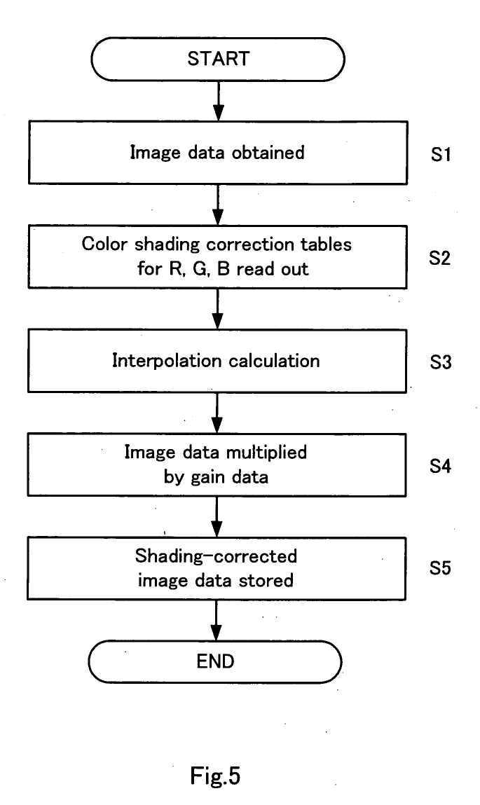

Next, the operations of the color shading correction and the brightness shading correction will be described. FIG. 5 is a flowchart showing an example of the operation associated with the color shading correction. First, image capturing is performed by the image sensor 21 and the taken image undergoes image processings such as the pixel interpolation and is stored in the image data storage area 451 of the image memory 45, whereby image data is obtained by the digital camera 1 (step S1). Then, the color shading correction tables for R, G and B prestored in the image memory 45 (the R, G and B color shading correction table storage areas 452 to 454) are read out, that is, the reference gain data written in the color shading correction tables is read out (step S2), and based on the reference gain data, the gain value for each pixel point of each block in the image area of each color (assumed image area corresponding to the taken image) is calculated based on the interpolation calculation by the DMA controllers 422 to 424 (step S3). Then, each piece of pixel data of the image data obtained at step S1 is multiplied by the reference gain data and the gain data (gain value) obtained by the interpolation at step S3 (step S4), and the image data having undergone the color shading correction which image data is multiplied by the gain data is stored in the shading-corrected image data storage area 455 of the image memory 45 (step S5). At step S4, the gain range adjustment by the range adjustment bit shifter 4052 may be performed on the image data multiplied by the gain data.

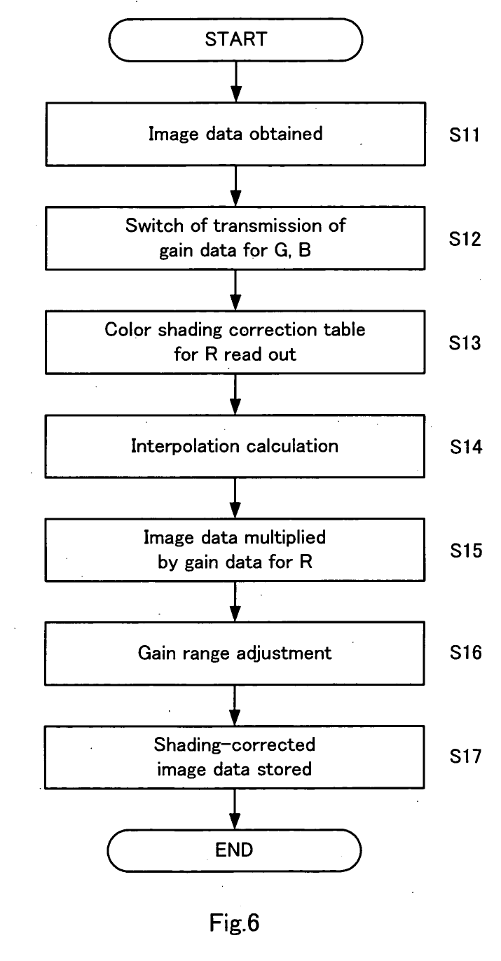

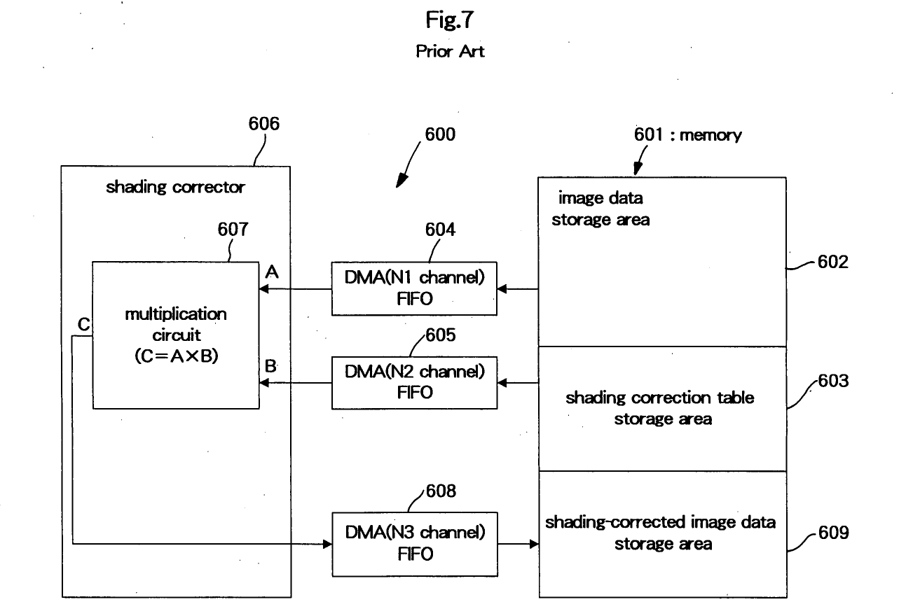

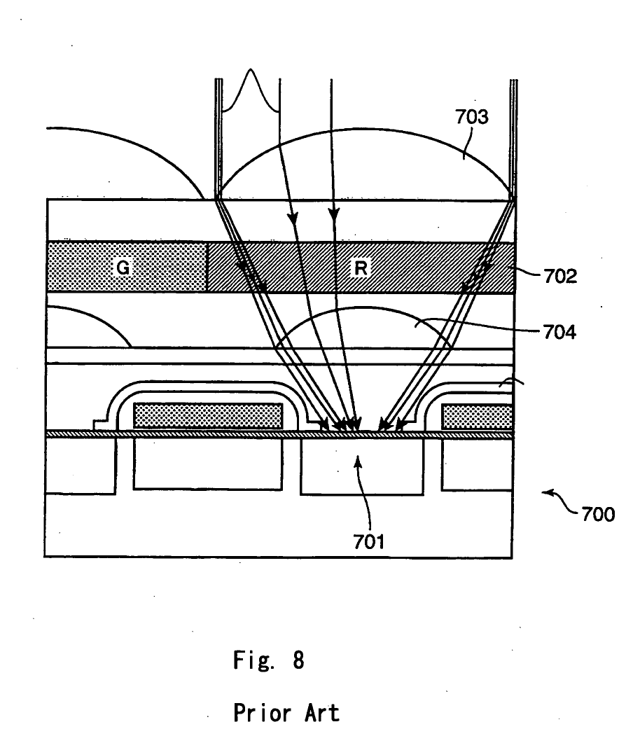

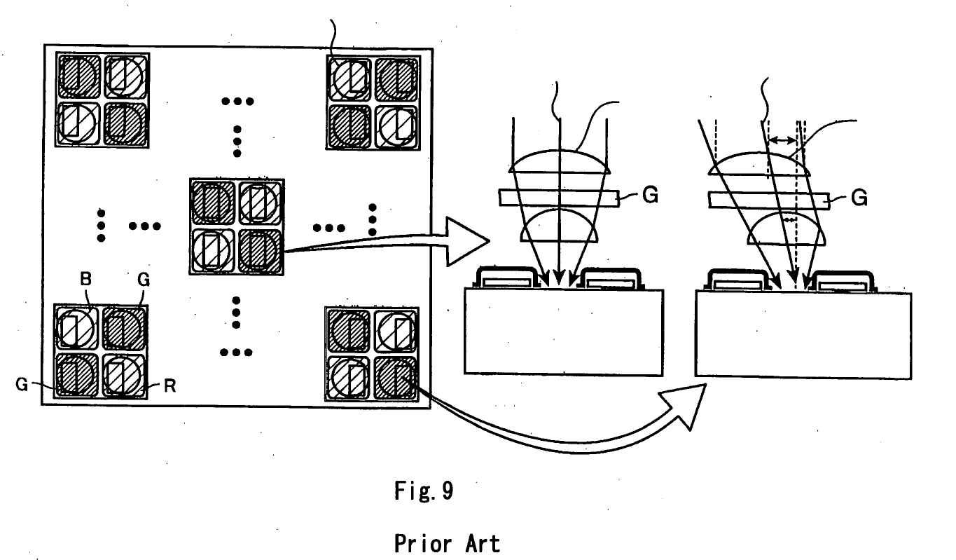

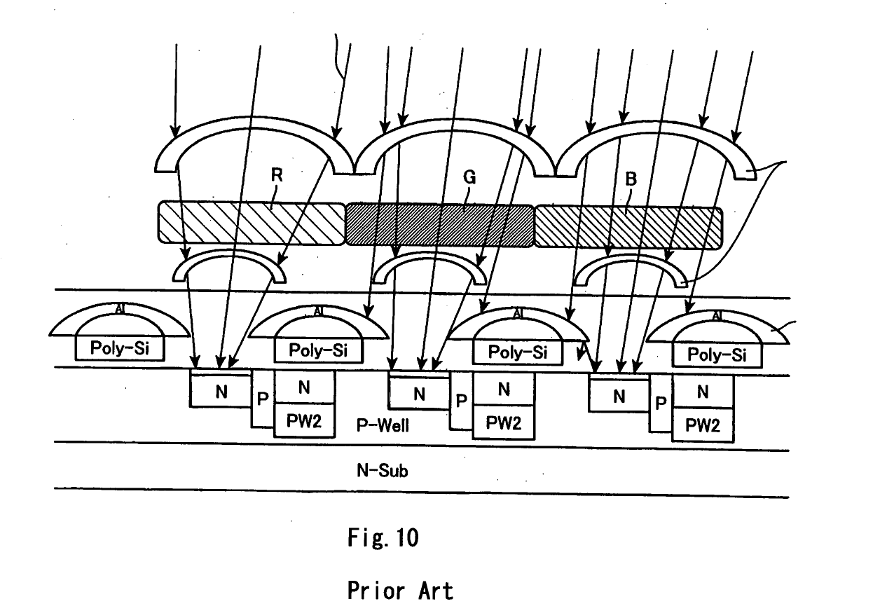

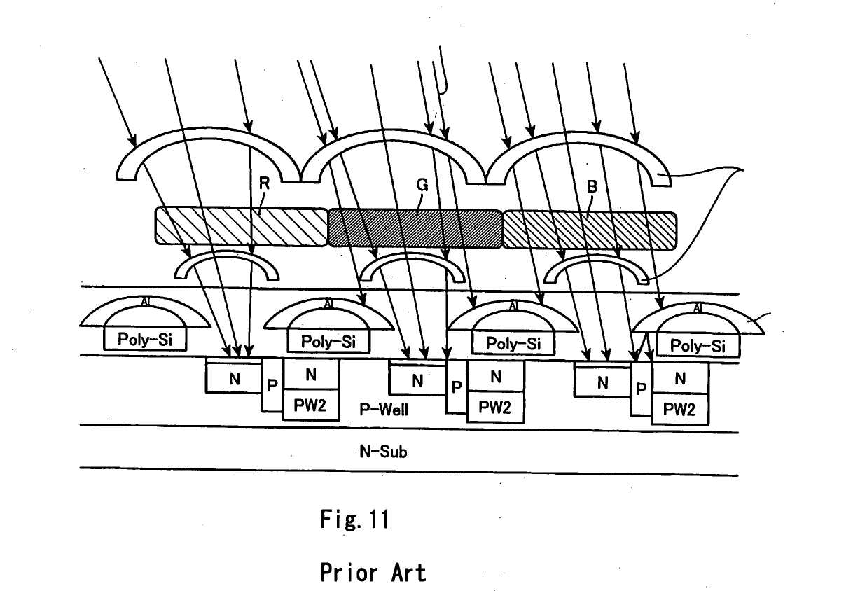

FIG. 6 is a flowchart showing an example of the operation associated with the brightness shading correction. First, image capturing is performed by the image sensor 21 and the taken image undergoes image processings such as the pixel interpolation and is stored in the image data storage area 451 of the image memory 45, whereby image data is obtained by the digital camera 1 (step S11). Then, for the unification to the gain data of one of R, G and B, the transmission of the gain data for G and B is switched (so as to be the transmission of the gain data for R) by the changeover switches SW1 and SW2 (step S12). On the other hand, the color shading correction table for one of R, G and B, for example, R prestored in the R shading correction table storage area 452 of the image memory 45 is read out, that is, the reference gain data for R written in the R shading correction table is read out (step S12), and based on the R reference gain data, the gain value for each pixel point in each block of the assumed image area for R is calculated based on the interpolation calculation by the DMA controller 422 (step S14).

Then, the gain data for each pixel for R obtained by the interpolation calculation at step S14 and the R reference gain data are inputted to the shading corrector 405 (the multiplication circuit 4051) not only as the gain data for R but also as the gain data for G and B by the switching by the changeover switches SW1 and SW2 at step S12. Then, each piece of pixel data of the image data obtained at step S11 is multiplied by these pieces of gain data (step S15), the range adjustment bit shifter 4052 performs the gain range adjustment on the image data multiplied by the gain data (step S16), and the image data having undergone the gain range adjustment is stored in the shading-corrected image data storage area 455 of the image memory 45 (step S17).

As described above, according to the image capturing apparatus (the digital camera 1) of the present invention, the image area 500 corresponding to the taken image is divided into a plurality of blocks, each block is provided with the reference gain data (information for the color shading correction) for each of R, G and B, the gain value for each pixel in each block is calculated by the interpolation calculation based on the reference gain data and the color shading correction is performed by use of these gain values (the gain values calculated by the interpolation calculation and the reference gain data), so that the capacity of the memory for storing the information for the color shading correction (color shading correction tables, etc.) can be reduced (cut down). Moreover, since the image area 500 is handled in a condition of being divided into a plurality of blocks, the block size can be arbitrarily set as required (according to the position within the image area) such that the sizes of the divisional blocks are small in parts of the image area 500 where the gain is large (the gain curve is steep). Moreover, since it is possible that the block size differs among R, G and B, accurate color shading correction for asymmetrical and complicated color shading can be performed. Moreover, since the image area 500 is divided into the plurality of blocks so that the block size decreases toward the periphery, for example, the gain generally increases (the steepness of the gain curve increases) toward the periphery (with respect to the center) of the image area 500, and the correction on the color shading such that the steepness of the gain curve increases toward the periphery can be easily and accurately performed.

Moreover, since the plurality of blocks have an individual block division pattern for each of R, G and B, that is, the block division pattern can be independently (arbitrarily) set for each color, the color shading correction for each of R, G and B can be performed by use of the block division pattern for each color without the block division pattern unified into one color, so that more accurate color shading correction for asymmetrical and complicated color shading can be performed.

Moreover, since the predetermined boundary pixel points between blocks within the image area 500 are pixel points at the corners in each block, the gain value for each pixel point in each block can be easily calculated by the interpolation calculation by use of the reference gain values (for example, the reference gain data G1 to G4) for each color at the pixel points at the corners.

Moreover, the gain value for each piece of pixel data of the taken image is made a unified gain value for one of R, G and B (for example, R) by the gain data transmission switching by the changeover switches SW1 and SW2, each piece of pixel data is multiplied by the unified gain value and the gain range (the gain for each piece of pixel data) for the taken image having undergone the gain value multiplication is adjusted by the range adjustment bit shifter 4052, so that not only the color shading correction by use of the gain value for each of R, G and B can be performed but also the brightness shading correction can be performed by use of the gain value unified into one color. Moreover, the brightness shading correction can be performed with a simple circuit structure using the existing circuit structure for performing the color shading correction without the provision of a separate circuit designed specifically for the brightness shading correction.

Further, since adjustment is performed by the range adjustment bit shifter 4052 in a larger gain range in the case of the brightness shading correction than in the case of the color shading correction, adjustment can be made so that the correction can be performed in an appropriate gain range in each of the color shading correction and the brightness shading correction.

The present invention can adopt the following modes:

(A) While the reference gain data in each block is set at the pixel positions (four positions) at the corners in the above-described embodiment, the present invention is not limited thereto; the reference gain data may be set at pixel points in given positions (for example, intermediate positions) on the sides (boundary lines) of each block and the number of set positions is not necessarily four. Moreover, the reference gain data in each block is not necessarily set on the sides and may be set for pixel points within each block. In this case, the gain values other than the reference gain data may be calculated not only by the interpolation but also by extrapolation or other interpolation methods.

(B) The shape of the blocks into which the image area is divided is not necessarily a quadrilateral such as a rectangle or a square; various block shapes such as a triangle and regular hexagons are adoptable. Moreover, the image area may be divided into blocks of a combination of various shapes.

(C) It is not always necessary that the block division pattern be different among R, G and B; for example, the block patterns may be set such that the same block division pattern is set for G and B and a different block division pattern is set for only R. By this, the capacity of the memory for storing the color shading correction table can be further reduced.

(D) A memory for storing the R, G and B color shading correction tables may be provided in addition to the image memory 45.

Although the present invention has been fully described way of examples with reference to the accompanying drawings, it is to be noted here that various changes and modifications will be apparent to those skilled in the art. Therefore, unless otherwise such changes and modifications depart from the scope of the present invention, they should be construed as being included therein.

What is claimed is:

1. An image capturing apparatus configured to correct a color shading of each of R, G and B in a captured image based on predetermined gain information for each pixel of the image, said image capturing apparatus comprising:
an image capturing portion that captures an image of an object;
a memory that has an area for storing reference gain information representative of a reference gain value for each of R, G and B at a predetermined pixel point in each block when an assumed image area corresponding to the captured image is divided into a plurality of blocks;
an interpolator that calculates the gain value for each color for each pixel in each block by an interpolation calculation based on the reference gain information stored in the memory; and
a shading corrector that receives interpolation gain information representative of the gain value calculated by the interpolator and the reference gain information, and performs color shading correction on the captured image based on the received interpolation gain information and reference gain information.

2. An image capturing apparatus as claimed in claim 1, wherein said gain information represents the reference gain value for each of R, G and B at a predetermined pixel point in each block when the assumed image area corresponding to the captured image is divided into a plurality of blocks having different sizes.

3. An image capturing apparatus as claimed in claim 2, wherein the assumed image area is divided into blocks so that blocks closer to the periphery of the assumed image area have smaller sizes.

4. An image capturing apparatus as claimed in claim 1, wherein the assumed image area is divided into blocks based on different block division patterns set among R, G and B.

5. An image capturing apparatus as claimed in claim 1, wherein said predetermined pixel point is located on a boundary line of each block.

6. An image capturing apparatus as claimed in claim 1, wherein said predetermined pixel point is located within each block

7. An image capturing apparatus as claimed in claim 1, wherein said memory stores the captured images.

8. An image capturing apparatus as claimed in claim 1, further comprising:
a gain switching member transmits the reference gain information and interpolation gain information for either one color among the R, G and B;
wherein said shading corrector performs brightness shading correction on the captured image based on the received interpolation gain information and reference gain information for the one color.

9. An image capturing apparatus as claimed in claim 8, further comprising:
a gain range adjustment shifter included in the shading corrector, and which adjusts a gain range in the brightness shading corrected image or a gain range in the color shading corrected image.

10. An image capturing apparatus as claimed in claim 9, wherein said gain range adjustment shifter is configured so that the adjustment in a larger gain range is performed upon brightness shading correction than upon color shading correction.

11. An image capturing apparatus configured to correct a color shading of each of R, G and B in a captured image based on predetermined gain information for each pixel of the image, said image capturing apparatus comprising:
an image capturing portion that obtains an image of an object;
a memory that has an area for storing reference gain information for each of R, G and B;
a shading corrector that performs color shading correction on the captured image based on the reference gain information received from the memory; and
a gain switching member that transfers, of the reference gain information for each of R, G and B stored in the memory, gain information for either one color to the shading corrector,
wherein the shading corrector performs brightness shading correction on the captured image based on the reference gain information for the one color transferred from the gain switching member.

12. An image capturing apparatus as claimed in claim 11, further comprising:
a gain range adjustment shifter included in the shading corrector, and which adjusts a gain range in the brightness shading corrected image or a gain range in the color shading corrected image.

13. An image capturing apparatus as claimed in claim 12, wherein said gain range adjustment shifter is configured so that the adjustment in a larger gain range is performed upon brightness shading correction than upon color shading correction.
